(19) United States
(12) Patent Application Publication
(10) Pub. No.: US 2022/0268275 A1
(43) Pub. Date: Aug. 25, 2022

(54) POSITIVE DISPLACEMENT PUMP SHAFT BEARING ASSEMBLY

(71) Applicant: BIGREP GMBH, Berlin (DE)

(72) Inventor: Sandro BAYER, Berlin (DE)

(73) Assignee: BIGREP GMBH, Berlin (DE)

(21) Appl. No.: 17/628,733

(22) PCT Filed: Jul. 29, 2020
(86) PCT No.: PCT/EP2020/071346

§ 371 Date: Jan. 20, 2022

(30) Foreign Application Priority Data
Jul. 31, 2019 (LU) LU101339

(51) Int. Cl. F04C 2/08; F01C 21/02

(52) U.S. Cl. CPC F04C 2/082; F01C 21/02; F04C 13/001

(57) ABSTRACT

The application relates to a positive displacement pump shaft bearing assembly that comprises a shaft having a shaft lodging and a shaft rotational axis. The assembly further comprises a housing having a housing lodging and one rolling element that is located between said lodgings. The rolling element comprises a rolling element centre point that coincides with the shaft rotational axis.

### FIELD

The present invention relates to 3D-printing or additive manufacturing. In particular, the present invention relates to a positive displacement pump shaft bearing assembly.

### BACKGROUND

In the field of additive manufacturing an additive manufacturing machine is also called a 3D-printer. In 3D-printing objects or workpieces are built/created/generated by subsequent depositing layers (beads or strands) of build material onto each other. This build material may be molten metal or plastic material and in particular, the depositing process may be the FFF process. The build material supplied to the 3D-printer may be filament or granulated material. Further, said build material may be deposited by a positive displacement pump.

The 3D-printer usually comprises a printhead that moves in three dimensions. Also, there are 3D-printers that comprise printhead that move in two dimensions and a printbed (the surface or structure on/to which the workpiece(s) are created) that moves in the third dimension. Also, there are printheads that are mounted to a conventional industrial robot such that the printhead can realize complex trajectories.

In the field of FFF printing, the printhead may comprise a melt pump or positive displacement pump that is supplied with build material in a depositable state. Such positive displacement pump may comprise at least one rotating shaft. Said build material is deposited through a nozzle that is connected to the positive displacement pump. The deposited build material forms a deposited strand that in turn forms one layer or part of a layer of the workpiece being built.

Positive displacement pumps usually comprise at least one rotating shaft of any sort. The bearing or lodging of said shaft is important for the function and reliability as well as the precision of the positive displacement pump. This precision may comprise inter alia the precision of starting output and/or the precision of the amount of deposited material. The here disclosed shaft bearing is not limited to a specific shaft comprised by a positive displacement pump.

Object of the present application is to improve said shaft bearing and thus increase the precision and reliability of a positive displacement pump.

This object is solved by a shaft bearing assembly for a positive displacement pump or a positive displacement pump shaft bearing assembly according to the appended independent claims.

A positive displacement pump shaft bearing assembly according to an aspect of the present application comprises a shaft having a shaft lodging and a shaft rotational axis. The assembly further comprises a housing having a housing lodging and the assembly further one rolling element that is located between said lodgings. The rolling element comprises a rolling element centre point that coincides with the shaft rotational axis. This may have the advantage that the friction and the break loose torque of the shaft is reduced. Consequently, the amount of build material deposited by the positive displacement pump may be controlled more finely. Also, the wear of the positive displacement pump is reduced. The positive displacement pump may be a gear pump and the rolling element may have any suitable form. The rolling element centre point is the geometrical centre point or middle point of the respective rolling element. Every rotational axis (rolling movement) of the respective rolling element passes through the rolling element centre point.

A shaft bearing assembly according to another aspect of the present application is disclosed wherein at least one of the shaft lodging and/or the housing lodging has one lodging form among: a conical-shape, a sphere-shape, a sphere-recessed-shape. This may have the advantage that the wear of the lodging is reduced. Also, the break loose torque is reduced.

A shaft bearing assembly according to another aspect of the present application is disclosed wherein the rolling element has point or line contact with the shaft lodging and/or the housing lodging. This may have the advantage that the wear of the lodging is reduced. Also, the break loose torque is reduced.

A shaft bearing assembly according to another aspect of the present application is disclosed wherein the shaft lodging and/or the housing lodging is adjustable in position parallel to the shaft rotational axis. This may have the advantage that the play within the shaft bearing assembly may be adjusted.

A shaft bearing assembly according to another aspect of the present application is disclosed wherein the shaft and/or housing lodging is threadedly connected with the shaft and/or the housing. This may have the advantage that the play within the shaft bearing assembly may be adjusted. Also, this may have the advantage that the maintenance of said assembly is facilitated.

A shaft bearing assembly according to another aspect of the present application is disclosed wherein at least one distance element is located between the shaft lodging and/or the housing lodging and the rolling element or at least one distance element is located between the shaft lodging and/or the housing lodging and the shaft and/or housing. This may have the advantage that the play within the shaft bearing assembly may be adjusted.

A shaft bearing assembly according to another aspect of the present application is disclosed wherein at least one fluid line is connected with the shaft lodging and/or the housing lodging. This may have the advantage that fluid may be supplied to the lodging. The fluid may for example be air or lubricant and/or coolant.

A shaft bearing assembly according to another aspect of the present application is disclosed wherein at least one of the shaft lodging, the housing lodging and the rolling element is case hardened and/or coated. This may have the advantage that wear of said assembly is reduced.

A shaft bearing assembly according to another aspect of the present application is disclosed wherein the rolling element is made from at least one of: metal or ceramics. This has the advantage that the material for the rolling element may be chosen according its coefficient of thermal expansion. By knowing the dimensions of the shaft bearing (e.g. size of the rolling element and dimensions of the housing and shaft lodging) and the operating temperature, the play of the shaft bearing assembly can be chosen/adjusted. Also, the rolling element may be a material mixture, e.g. having a metal core with a ceramic outer layer or vice versa.

According to another aspect of the present application a positive displacement pump is disclosed, comprising at least one shaft bearing assembly according to any of the above aspects. This may have the advantage that the positive displacement pump may have an increased precision. Even if a shaft of the shaft bearing assembly has two or more bearings or lodgings, only one may comprise a shaft bearing assembly according to the present invention. In other words, in a positive displacement pump not all bearings or lodgings have to be of the here disclosed kind.

A positive displacement pump according to another aspect of the present application may be a gear pump. This may have the advantage that the precision of said positive displacement pump may further be increased.

The above aspects may be freely combined. For a better understanding of the invention the latter will be explained in view of the appended figures. The figures respectively show in very simplified and schematically depiction:

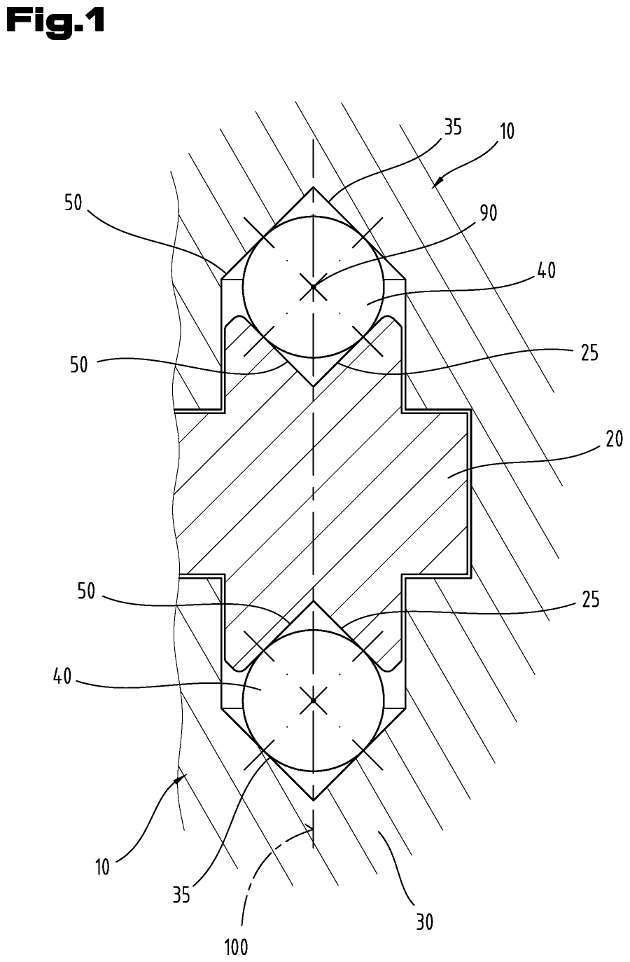

FIG. 1 depicts a cross sectional view of assemblies according to one embodiment.

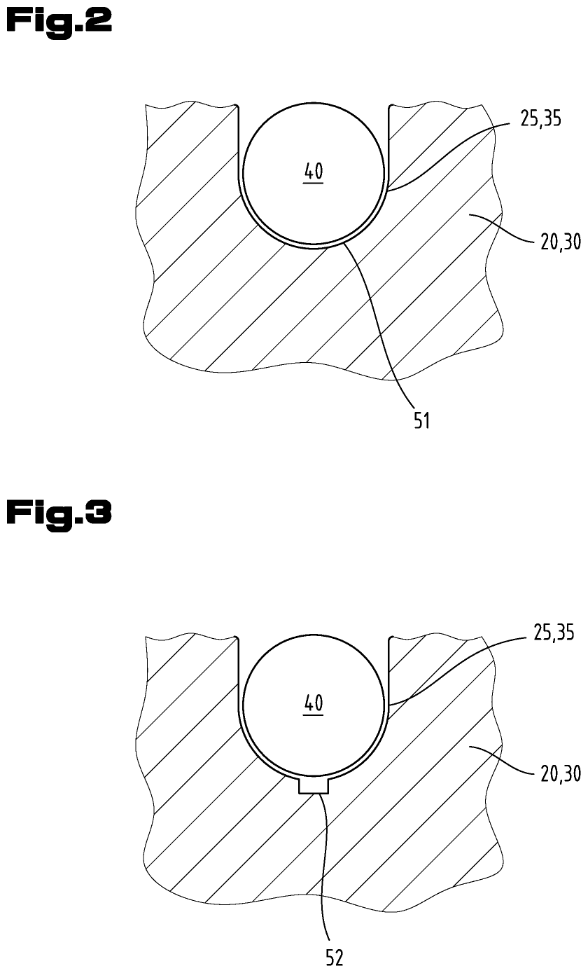

FIG. 2 depicts a cross sectional view of a further example of a housing lodging and/or a shaft lodging.

FIG. 3 depicts a cross sectional view of a further example of a housing lodging and/or a shaft lodging.

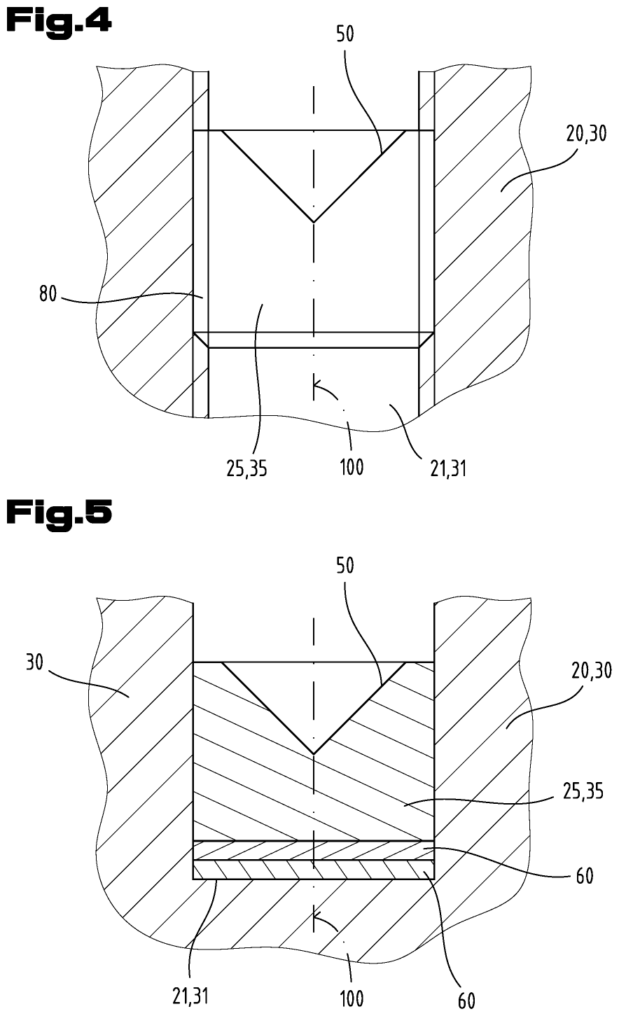

FIG. 4 depicts a cross sectional view of a further example of a housing lodging and/or a shaft lodging.

FIG. 5 depicts a cross sectional view of a further example of a housing lodging and/or a shaft lodging.

It is to be noted that in the different embodiments/variations described herein same parts/elements are numbered with same reference signs, however, the disclosure in the detailed description may be applied to all parts/elements having the regarding reference signs. Also, the directional terms/position indicating terms chosen in this description like up, upper, down, lower downwards, lateral, sideward are referring to the directly described figure and may correspondingly be applied to the new position after a change in position or another depicted position in another figure.

### DETAILED DESCRIPTION OF THE FIGURES

FIG. 1 depicts a sectional view of an embodiment of two shaft bearing assemblies 10 each comprising a rolling element 40, a housing lodging 35 and a shaft lodging 25. A shaft 20 comprises the two depicted shaft lodgings 25 and a housing 30 comprising the two depicted housing lodgings 35. Both housing lodgings 35 comprise each a conical-shape 50. Both shaft lodgings 25 comprise each a conical-shape 50. Each rolling element 40 has a rolling element centre point 90.

In FIG. 1 the rolling elements 40 are arranged between each shaft lodging 25 and the respective housing lodging 35. The shaft 20 comprises a shaft rotational axis 100 about which the shaft 20 rotates. Said shaft rotational axis 100 coincides with both rolling element centre points 90 of the rolling elements 40. In other words, in the depicted embodiment of FIG. 1 both rolling element centre points 90 are located on the shaft rotational axis 100.

FIG. 2 depicts a variation of the shaft lodging 25 and/or the housing lodging 35 depicted in FIG. 1. Here, the lodging has a sphere-shape 51 in which the rolling element 40 is located. The shaft lodging 25 or the housing lodging 35 is comprised in either a housing 30 or a shaft 20.

FIG. 3 depicts a further variation of the shaft lodging 25 and/or the housing lodging 35 depicted in FIG. 2. Here, the lodging has a recessed sphere-shape 52 in which the rolling element 40 is located. The recessed sphere-shape 52 may have the advantage that the rolling element 40 only has a line contact in the area where the spherical form is recessed or at the transition from the sphere to the recess. This may further reduce friction. The shaft lodging 25 or the housing lodging 35 is comprised in either a housing 30 or a shaft 20. Also, the conical-shape 50 depicted e.g. in FIG. 1 may be recessed in the tip-area of the conical shape.

FIG. 4 depicts a further variation of the shaft lodging 25 and/or the housing lodging 35 depicted in FIG. 2. Here, the lodging is movable within the shaft 20 or housing 30 by means of a thread 80. The thread 80 is located in a shaft lodging bore 21 or a hosing lodging bore 31. By means of the thread, the shaft lodging 25 and/or the housing lodging 35 may be moved parallel to the shaft rotational axis 100. The shaft lodging 25 and/or the housing lodging 35 may have any known drive or engagement structure to rotate the shaft lodging 25 and/or the housing lodging 35 in order to cause a movement in parallel to said axis 100. The engagement structure may for example be a structure for a hexagon socket key, a torx or slot.

FIG. 5 depicts a further variation of the shaft lodging 25 and/or the housing lodging 35 depicted in FIG. 2. Here, the lodging is placed in the shaft 20 and/or the housing 30 using at least one distance element 60 (in FIG. 5 two distance elements 60 are depicted). By means of the at least one distance element 60 and its dimension parallel to said axis 100, the position of the shaft lodging 25 and/or the housing lodging 35 in the shaft lodging bore 21 and/or the hosing lodging bore 31 in parallel to said axis 100 may be adjusted and consequently the play of a shaft bearing assembly may be adjusted. The distance elements 60 in FIG. 5 are depicted between the shaft lodging 25 and/or the housing lodging 35 and the shaft 20 and/or the housing 30. However, it is also possible to locate at least one distance element between the respective lodging and the respective rolling element. In this case, the distance element preferably has the shape of the respective lodging it is placed into and any of the above lodging shapes in which the rolling element 40 is then placed. The shaft lodging bore 21 or the hosing lodging bore 31 are depicted as blind holes.

FIGS. 2 to 5 depict variations of a housing lodging and a shaft lodging. However, they might be freely combined, e.g. the shaft lodging may comprise a conical-shape and the housing lodging may comprise a sphere-shape. Also, the disclosure of FIGS. 4 and 5 may be freely combined. For example, a sphere-shaped housing lodging may comprise a thread and further optionally at least a distance element on either side of the lodging. Also, in FIGS. 2 to 5 the other from housing/housing lodging or shaft/shaft lodging is not depicted.

In all figures like reference sings are used for like or similar parts/elements as in the other figures. Thus, a detailed explanation of such part/element will only be given one for the sake of brevity.

The embodiments depict possible variations of carrying out the invention, however, it is to be noted that the invention is not limited to the depicted embodiments/variations but numerous combinations of the here described embodiments/variations are possible and these combinations lie in the field of the skills of the person skilled in the art being motivated by this description.

The scope of protection is determined by the appended claims. The description and drawings, however, are to be considered when interpreting the claims. Single features or feature combinations of the described and/or depicted features may represent independent inventive solutions. The object of the independent solutions may be found in the description.

All notations of ranges of values in the present description are to be understood as to also comprise and disclose all arbitrary sub-ranges therein, e.g. the disclosure 1 to 10 is to be understood that all sub-ranges starting from the lower limit 1 up to the upper limit 10 are also comprised and disclosed, i.e. all sub-ranges starting with a lower limit of 1 or bigger and end with an upper limit of 10 or smaller, e.g. 1 to 1.7, or 3.2 to 8.1, or 5.5 to 10. Only one digit after the comma is described, however the same applies mutates mutandis to any given number of digits after the comma.

It is further to be noted that for a better understanding parts/elements are depicted to some extend not to scale and/or enlarged and/or down scaled.

### REFERENCE SIGN LIST

10 shaft bearing assembly
20 shaft
21 shaft lodging bore
25 shaft lodging
30 housing
31 housing lodging bore
35 housing lodging
40 rolling element
50 conical-shape
51 sphere-shape
52 sphere-recessed-shape
60 distance element
80 thread
90 rolling element centre point
100 shaft rotational axis

1. A positive displacement pump shaft bearing assembly (10), comprising a shaft (20) having a shaft lodging (25) and a shaft rotational axis (100), a housing (30) having a housing lodging (35) and one rolling element (40) located between said lodgings (25, 35), wherein the rolling element (40) comprises a rolling element center point (90) that coincides with the shaft rotational axis (100).

2. The shaft bearing assembly (10) according to claim 1, wherein at least one of the shaft lodging (25) or the housing lodging (35) has one lodging form selected among: a conical-shape (50), a sphere-shape (51), or a sphere-recessed-shape (52).

3. The shaft bearing assembly (10) according to claim 1, wherein the rolling element (40) has point or line contact with the shaft lodging (25) or the housing lodging (35).

4. The shaft bearing assembly (10) according to claim 1, wherein the shaft lodging (25) and/or the housing lodging (35) is adjustable in position parallel to the shaft rotational axis (100).

5. The shaft bearing assembly (10) according to claim 1, wherein the shaft lodging (25) and/or the housing lodging (35) is threadedly connected with the shaft (25) or the housing (30).

6. The shaft bearing assembly (10) according to claim 1, wherein at least one distance element (60) is located between the shaft lodging (25) or the housing lodging (35) and the rolling element (40), or at least one distance element (60) is located between the shaft lodging (25) and/or the housing lodging (35) and the shaft (20) and/or the housing (30).

7. The shaft bearing assembly (10) according to claim 1, wherein at least one fluid line (70) is connected with the shaft lodging (25) or the housing lodging (35).

8. The shaft bearing assembly (10) according to claim 1, wherein at least one of the shaft lodging (25), the housing lodging (35) and the rolling element (40) is case hardened and/or coated.

9. The shaft bearing assembly (10) according to claim 1, wherein the rolling element (40) is made from at least one material chosen among: metal, ceramics.

10. A positive displacement pump comprising at least one shaft bearing assembly (10) according to claim 1.

11. A positive displacement pump according to claim 10, wherein the positive displacement pump is a gear pump.
